(19) United States
(12) Patent Application Publication
(10) Pub. No.: US 2023/0252335 A1
(43) Pub. Date: Aug. 10, 2023

(54) MACHINE LEARNING-BASED BRANCHING AND DIVING FOR SOLVING COMBINATORIAL OPTIMIZATION COMPUTATIONAL PROBLEM

(71) Applicant: Davidson Technologies, Inc., Huntsville, AL (US)

(72) Inventors: Jonathan SEWELL, Huntsville, AL (US); Charles HARTSELL, Madison, AL (US)

(21) Appl. No.: 18/166,840

(22) Filed: Feb. 9, 2023

Related U.S. Application Data
(60) Provisional application No. 63/267,759, filed on Feb. 9, 2022.

(51) Int. Cl. G06N 10/60; G06N 3/08; G06N 3/045

(52) U.S. Cl. CPC G06N 10/60; G06N 3/08; G06N 3/045

(57) ABSTRACT

Various embodiments include systems, methods, and non-transitory computer-readable media for using machine learning (ML)-based branching and diving to solve a computational problem that comprises a combinatorial optimization problem.

### CROSS-REFERENCE TO RELATED APPLICATION

This application claims priority to and the benefit of U.S. Provisional Patent Application No. 63/267,759, filed on Feb. 9, 2022, which is incorporated herein by reference.

### TECHNICAL FIELD

The present disclosure generally relates to data processing and management. In particular, various embodiments described herein provide systems, methods, techniques, instruction sequences, and devices that use machine learning (ML)-based branching and diving to solve a computational problem that comprises a combinatorial optimization problem.

### BACKGROUND

The goal of optimization is to find an input vector x which maximizes or minimizes the value of an objective function ƒ(x). Often these problems are constrained, meaning there are one or more properties (e.g., described by P(x)) that need to be satisfied for a given input vector to be valid. Solving optimization problems involves searching the space of all possible input vectors to identify a vector (or multiple vectors if the solution is not unique) that satisfy all required properties and results in an optimal value by the objective function.

Combinatorial and integer optimization problems (hereafter, combinatorial optimization problems), such as those in the form of Equation 1 (provided below), restrict the allowed range of inputs to discrete-valued vectors, and disallow real-valued inputs.

$$Equation 1 defines a combination optimization problem as$$

$$\begin{matrix}{min}_{x} f ( x ) subject to \\ x ∈ {ℤ}^{n} , P ( x ) is true ,\end{matrix}$$

where x is a vector of finite length, ƒ(x) is the objective function to be optimized (ƒ(x) is either minimized or maximized) over choices for x, Zⁿ is the set of ordered n-tuples of integers, and P(x) is a property of x describing the satisfaction of various constraints (e.g., upper and lower bounds on the value of x, equality and inequality constraints against arbitrary functions of x, etc.). The restriction of combinatorial optimization problems to an integer input space renders combinatorial optimization problems harder to solve than equivalent continuous-valued problems. Techniques for solving combinatorial optimization problems are well studied in the field of Discrete Optimization.

The size of the solution space for a combinatorial optimization problem grows exponentially as the complexity of the combinatorial optimization problem increases, thereby making brute-force search algorithms intractable for all but the simplest combinatorial optimization problems.

Branch-and-bound is a common divide-and-conquer technique used to subdivide and search the solution space of a combinatorial optimization problem in a more efficient manner than a brute force search. This subdivision of the solution space is typically performed many times, resulting in a branch-and-bound tree where the root of the tree represents the original problem and each branch (to a node) in the tree is another subdivision of the solution space with a corresponding simplified version of the original problem. For each individual node, a dual bound is calculated and provides a conservative limit on the level of optimality of any solutions existing within the portion of the solution space corresponding to the individual node. In certain cases, this dual bound can be used to eliminate an individual node in the tree from consideration, preventing any further exploration of the individual node.

Additionally, branch-and-bound comprises a diving step that attempts to “short-circuit” the iterative solving process and jump directly to a complete solution. The probability of finding a near-optimal solution through diving is usually very low at the beginning of the solving process, but the identified solutions can be useful for guidance even when the identified solutions are far from optimal.

Both the branching and the diving techniques involve choices to be made regarding how a solution space should be subdivided and how complete solutions should be quickly identified respectively. The specific methods for making these choices are known as policies.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of example, and not limitation, in the figures of the accompanying drawings.

FIG. 1 is a block diagram showing an example networked environment that includes a machine-learning-branching-and-diving-based combinatorial problem solver, according to various embodiments of the present disclosure.

FIG. 2 is a block diagram illustrating an example neural-branching-and-diving-based combinatorial optimization problem solver, according to various embodiments of the present disclosure.

FIG. 3 through FIG. 4 are flowcharts illustrating example methods for a ML-based branching technique and a ML-based diving technique to solve a computational problem that comprises a combinatorial optimization problem, according to various embodiments of the present disclosure.

FIG. 5 illustrates an example application of a branch-and-bound algorithm to generate an example branch-and-bound tree, according to various embodiments of the present disclosure.

FIG. 6 is a block diagram illustrating a representative software architecture, which may be used in conjunction with various hardware architectures herein described, according to various embodiments of the present disclosure.

FIG. 7 is a block diagram illustrating components of a machine able to read instructions from a machine storage medium and perform any one or more of the methodologies discussed herein according to various embodiments of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter may be practiced without these specific details.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various embodiments may be given throughout this description. These are merely descriptions of specific embodiments. The scope or meaning of the claims is not limited to the embodiments given.

Various embodiments described herein provide for using a machine learning-based (e.g., neural) branching technique and a machine learning-based (e.g., neural) diving technique to solve a computational problem that comprises a combinatorial optimization problem. In particular, various embodiments provide an optimal or near-optimal solution to a combinatorial optimization problem (e.g., in the form of Equation 1), and can do this by repeated application of machine learning (ML)-based (e.g., neural) branching, machine learning (ML)-based (e.g., neural) diving, and solving unconstrained binary optimization (UBO) problems (e.g., solving UBOs via a quantum computer-based solver, such as a quantum annealer). For instance, some embodiments transform the combinatorial optimization problem (e.g., in the form of Equation 1) to an unconstrained pseudo-Boolean optimization problem and, additionally convert the pseudo-Boolean optimization problem with constraints to a quadratic unconstrained binary optimization (QUBO) problem, which can be solved using a quantum computer-based solver, such as a quantum annealing computer (or quantum annealer). According to some embodiments, ML-based branching comprises a branch-and-bound technique for searching the solution space of a combinatorial optimization problem, where the branching/subdividing policy (e.g., decision to branch or subdivide a solution space) is based on a trained machine model (e.g., trained neural network). Additionally, according to some embodiments, ML-based diving comprises a diving technique for identifying a complete solution of a combinatorial optimization problem, where the diving/identification policy (e.g., how a complete solution is identified) is based on a trained machine model (e.g., trained neural network), which can be different from the one used by the ML-based branching.

In particular, various embodiments solve the combinatorial optimization problem (e.g., in the form of Equation 1) by transforming (e.g., expressing) the combinatorial optimization problem as a pseudo-Boolean optimization problem (e.g., in the form of Error! Reference source not found, provided below), such that each solution of the pseudo-Boolean optimization problem is transformable into a solution of the Error! Reference source not found.

$$Equation 2 defines a pseudi - Boolean optimization problem as$$

$$\begin{matrix}{min}_{y} {\sum }_{I ⊆ \{ 1 , 2 , … , m \}} {α}_{I} {\prod }_{i ∈ I} {y}_{i} subject to \\ y ∈ {\{ 0 , 1 \}}^{m} , \\ {\sum }_{I ⊆ \{ 1 , 2 , … , m \}} {α}_{I}^{j , \leq } {\prod }_{i ∈ I} {y}_{i} \leq {c}_{j}^{\leq } for j ∈ \{ 1 , 2 , … , {k}_{\leq } \} , \\ {\sum }_{I ⊆ \{ 1 , 2 , … , m \}} {α}_{I}^{j , =} {\prod }_{i ∈ I} {y}_{i} = {c}_{j}^{=} for j ∈ \{ 1 , 2 , … , {k}_{=} \} ,\end{matrix}$$

where y is a vector of finite length m such that each element of y can take on one of two values only (e.g., 1 and 0, or −1 and +1, etc.), l is a subset of the numbers 1 through m, aᵢ is the coefficient in the objective function associated with the product of yᵢ variables over the set l of indices (e.g., if l={1, 6, 7}, then the product associated with l is y₁y₆y₇ and the coefficient of this term in the summation is a_{1,6,7}), k is the number of constraints (possibly different from the k in the combinatorial optimization problem), aₗ^{j} is the coefficient in constraint j associated with the product of yᵢ variables over the set l of indices, and cⱼ is the scalar bound for constraint j. Equation 3 defines optimization problem transformation requirements as:

ƒ(x)=h(T_{xy}(x)) for all x∈ [symbol] such that P(x) is true

and

h(y)=ƒ(T_{yx}(y)) for all y∈{0,1}^{m} such that

Σ_{I⊆{1,2, . . . ,m}}αₗ^{j,≤}Π_{i∈l}yᵢ≤cⱼ^{≤} for j∈{1,2, . . . ,k_{≤}},

Σ_{I⊆{1,2, . . . ,m}}αₗ^{j,=}Π_{i∈l}yᵢ=cⱼ⁼ for j∈{1,2, . . . ,k₌},

where h(y)=Σ_{I⊆{1,2, . . . ,m}}αₗΠ_{i∈l}yᵢ is the objective function of the pseudo-Boolean optimization problem, T_{xy}(x) is a function that transforms solutions of the combinatorial optimization problem into solutions (e.g., viable solutions) of the pseudo-Boolean optimization problem, and T_{yx}(y) is a function that transforms solutions (e.g., viable solutions) of the pseudo-Boolean optimization problem into solutions (e.g., viable solutions) of the combinatorial optimization problem. For some embodiments, the transformation function T_{xy} is able to transform a partial solution such that if a vector xₚₐᵣₜᵢₐₗ of length n is assigned integers to certain positions and the remaining positions are left unassigned, then yₚₐᵣₜᵢₐₗ=T_{xy}(xₚₐᵣₜᵢₐₗ) will have some positions assigned to binary values (e.g., one or zero) and the remaining positions will be left unassigned. The transformation function T_{yx} may or may not have this partial assignment property. By having the ability to transform between a combinatorial optimization problem and a pseudo-Boolean optimization problem, an embodiment described herein can perform each operation at the most impactful places within the overall algorithm.

According to some embodiments, ML-based branching and ML-based diving are performed on a combinatorial form (e.g., in the form of Equation 1) of a combinatorial optimization problem. From here, a transform function T_{xy} can be used to transform the problem with a partial assignment of variables into a pseudo-Boolean form of the combinatorial optimization problem (e.g., in the form of Equation 2). Along one path, the pseudo-Boolean form is used to determine a dual bound. Along another path, additional transformations are performed to prepare input data for processing (e.g., solving) using a quantum computer-based solver, such as a quantum annealing computer. After the prepared input data are processed using the quantum computer-based solver (e.g., submitted to the quantum computer-based solver via a cloud-based service), output data resulting from the quantum computer-based solver are used to determine a primal bound, and the output data is transformed back to the combinatorial form of a solution via the transformation function 7yx. At this point, the ML-based diving or ML-based branching can be performed again if exit conditions are not met.

Various embodiments described herein can be applied to different types of problems and use cases. For example, an embodiment can be used to determine (e.g., generate) a solution for a route optimization problem, such as the travelling salesperson problem. For instance, given a list of locations to visit and the travel time between each pair of locations, an embodiment can be used to determine an order in which to visit locations so that the total distance travelled is the smallest required to visit all locations. As another example, an embodiment can be used to determine (e.g., generate) a solution for an assignment problem, such as a flight schedule optimization. For instance, given a list of airplane locations, airplane capabilities, demands for passengers to fly from one location to another at given times, and constraints (e.g., maximum flight time before maintenance is required), an embodiment can be used to determine a flight schedule for each airplane that maximizes the average number of passengers per flight. As another example, an embodiment can be used to determine (e.g., identify) a resource number and a location optimization problem, such as hospital planning for a city. For instance, given a graph consisting of vertices (each of which represents a possible location for a business) and edges (each of which represents the possibility of vehicle transmit between two possible business locations and is associated with a number representing the worst-case transit time required to go between these two locations), and a desired maximum ambulance response time, an embodiment can be used to determine a minimum number of hospitals (and their respective locations) to ensure all locations can be reached by an ambulance starting from a hospital within the desired maximum ambulance response time. For each example problem or use case, an appropriate computational problem that comprises a combinatorial optimization problem is generated or constructed, where the combinatorial optimization problem relates to, describes, or otherwise represents the example problem/user case to be solved.

As used herein, a computational problem (or programming problem) can refer to a problem (e.g., data describing a problem) that is configured to be processed by a computer system (e.g., non-quantum computer or a quantum computer) to determine one or more solutions to the problem. For example, a combinatorial optimization computational problem can comprise a computational problem that embodies a combinatorial optimization problem. A pseudo-Boolean optimization computational problem can comprise a computational problem that embodies a pseudo-Boolean optimization problem.

An unconstrained binary optimization (UBO) computation problem can comprise a computational problem that embodies an unconstrained binary optimization (UBO) problem. A quadratic unconstrained binary optimization (QUBO) computation problem can comprise a computational problem that embodies a quadratic unconstrained binary optimization (QUBO) problem.

As used herein, a classic computer (also referred to herein as a classic computer device or a classic computer system) refers to a non-quantum computer that operates using a non-quantum processor (e.g., digital hardware processor, such as a general-purpose processor or central processing unit (CPU)), which processes information as bits. As used herein, a quantum computer-based solver comprises, or is implemented using, a quantum computer. A quantum computer (also referred to as a quantum computing device or a quantum computer system) can comprise physical computer/computational hardware that perform computational tasks using quantum technology (e.g., at least one quantum hardware processor) that leverages quantum physics and quantum phenomena to process information (e.g., binary information) via one or more qubits. A qubit is a basic unit of information in a quantum computer, and is generally implemented by a physical circuit or device that operates using the quantum physic principles of superposition (which permits a qubit to have a quantum state representing a superposition of two values (e.g., 0 and 1) simultaneously), entanglement (which permits the state of the qubit (e.g., state of being a superposition of 1 and 0) being dependent on the state of another qubit), or both. There are different types of quantum computers, and the architecture and physical implementation of a qubit can differ between different types of quantum computer and their respective manufacturers. For instance, examples of different types of qubits include, without limitation, superconducting qubits, photonic qubits, trapped ion qubits, topological qubits, quantum dot qubits, and nuclear magnetic resonance qubits. Examples of a quantum computer can include, without limitation, a quantum annealing computer (also referred to as a quantum annealer) or a universal gate quantum computer (which comprises one or more quantum logic gates or circuits that can be interconnected to form a quantum circuit to perform one or more logic operations on a qubit). Depending on the embodiment, a quantum computer used for various operations as described herein can form part of a non-quantum computer (e.g., quantum co-processor) or can be external to a non-quantum computer and operatively coupled to the non-quantum computer (e.g., by way of an electronic connection). For some embodiments, a quantum computer used herein is provided over a network (e.g., use/access of the quantum computer can be provided by a cloud-based computing resource, a quantum processing platform, or as software as a service). Alternatively, or additionally, the quantum computer can be implemented as local hardware (e.g., quantum co-processor) that is a part of a non-quantum computer configured to perform non-quantum computer operations in accordance with an embodiment.

As used herein, a policy can refer to a method of deciding between alternatives (e.g., making decisions randomly with uniform probability between alternatives is a policy). A branching policy can refer to a method of deciding between alternatives as part of a branch-and-bound algorithm, and a diving policy can refer to a method of deciding between alternatives as part of a diving algorithm.

As used herein, a dual bound refers to a lower bound of a combinatorial optimization problem that is a minimization problem, and a primal bound refers to an upper bound of a combinatorial optimization problem that is a minimization problem. As used herein, a dual bound refers to an upper bound of a combinatorial optimization problem that is a maximization problem, and a primal bound refers to a lower bound of a combinatorial optimization problem that is a maximization problem.

Though various embodiments are described herein as using a quantum computer (e.g., quantum computer-based solver) to perform certain operations (e.g., solving UBO problems), it will be understood that other embodiments can use an alternative form of computing hardware for perform operations described herein, such as a neuromorphic processor-based, a graphic processing unit (GPU)-based, or a general purpose computer processor (e.g., central processing unit (CPU) or digital processor)-based solver.

Further, though various embodiments are described herein as using a neural branch-and-bound algorithm or neural branching, it will be understood that other embodiments can use any form of machine learning (i.e., not just a neural network) to implement its branching policy. Similarly, though various embodiments are described herein as using a neural diving algorithm or neural diving, it will be understood that other embodiments can use any form of machine learning (i.e., not just a neural network) to implement its diving policy.

Reference will now be made in detail to embodiments of the present disclosure, examples of which are illustrated in the appended drawings. The present disclosure may, however, be embodied in many different forms and should not be construed as being limited to the embodiments set forth herein.

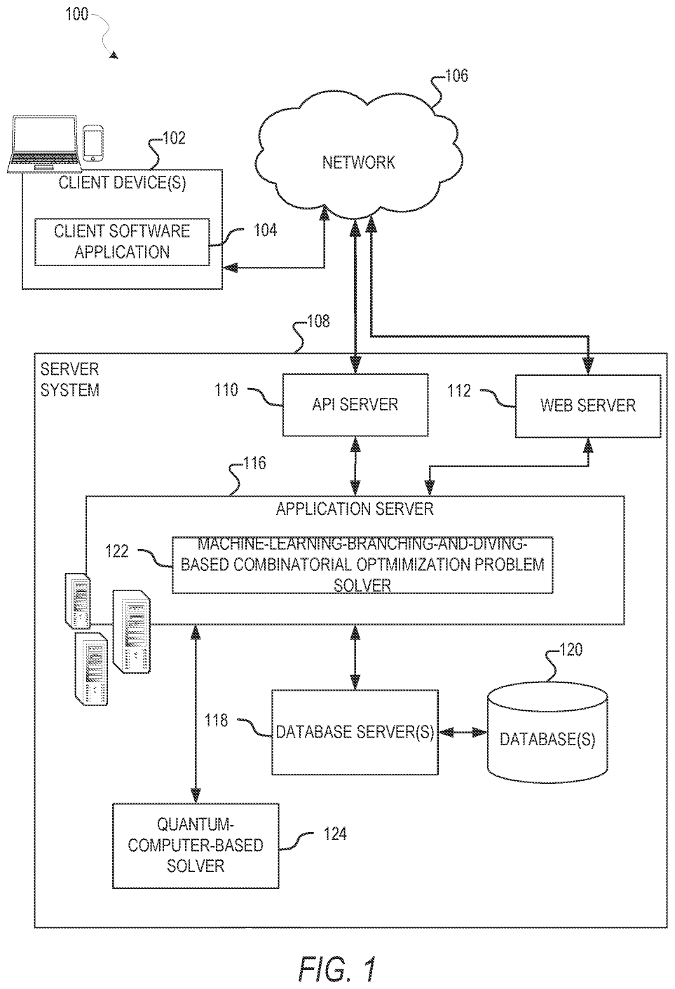

FIG. 1 is a block diagram showing an example networked environment 100 that includes a machine-learning-branching-and-diving-based combinatorial optimization problem solver 122, according to various embodiments of the present disclosure. By including the machine-learning-branching-and-diving-based combinatorial optimization problem solver 122 (hereafter, the MLBAD-based combinatorial optimization problem solver 122), the networked environment 100 can use ML-based branching and ML-based diving to solve a computational problem that comprises a combinatorial optimization problem. For instance, a user at the client device 102 can access the MLBAD-based combinatorial optimization problem solver 122 and cause the MLBAD-based combinatorial optimization problem solver 122 to use a ML-based branching technique and a ML-based diving technique (e.g., to explore a solution space) to determine a complete combinatorial solution for a computational problem that comprises a combinatorial optimization problem.

As shown, the networked environment 100 includes one or more client devices 102, a server system 108, and a network 106 (e.g., including the Internet, wide-area-network (WAN), local-area-network (LAN), wireless network, etc.) that communicatively couples them together. Each client device 102 can host a number of applications, including a client software application 104. The client software application 104 can communicate data with the server system 108 via a network 106. Accordingly, the client software application 104 can communicate and exchange data with the server system 108 via network 106.

The server system 108 provides server-side functionality via the network 106 to the client software application 104. While certain functions of the networked environment 100 are described herein as being performed by the MLBAD-based combinatorial optimization problem solver 122 on the server system 108, it will be appreciated that the location of certain functionality within the server system 108 is a design choice. For example, it may be technically preferable to initially deploy certain technology and functionality within the server system 108, but to later migrate this technology and functionality to the client software application 104.

The server system 108 supports various services and operations that are provided to the client software application 104 by the MLBAD-based combinatorial optimization problem solver 122. Such operations include transmitting data from the MLBAD-based combinatorial optimization problem solver 122 to the client software application 104, receiving data from the client software application 104 to the MLBAD-based combinatorial optimization problem solver 122, and the MLBAD-based combinatorial optimization problem solver 122 processing data generated by the client software application 104. This data may include, for example, requests and responses relating to solving an optimization problem (e.g., combinatorial optimization problem), parameters for performing ML-based branching (e.g., number of iterations limits, execution time limit, and the like), parameters for performing ML-based diving (e.g., number of iterations limits, execution time limit, and the like). Data exchanges within the networked environment 100 may be invoked and controlled through operations of software component environments available via one or more endpoints, or functions available via one or more user interfaces of the client software application 104, which may include web-based user interfaces provided by the server system 108 for presentation at the client device 102.

With respect to the server system 108, each of an Application Program Interface (API) server 110 and a web server 112 is coupled to an application server 116, which hosts the MLBAD-based combinatorial optimization problem solver 122. The application server 116 is communicatively coupled to a database server 118, which facilitates access to a database 120 that stores data associated with the application server 116, including data that may be generated or used by the MLBAD-based combinatorial optimization problem solver 122.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke functionality of the application server 116. The API server 110 exposes various functions supported by the application server 116 including, without limitation: user registration; login functionality; data object operations (e.g., generating, storing, retrieving, encrypting, decrypting, transferring, access rights, licensing, etc.); and user communications.

Through one or more web-based interfaces (e.g., web-based user interfaces), the web server 112 can support various functionality of the MLBAD-based combinatorial optimization problem solver 122 of the application server 116.

The application server 116 hosts a number of applications and subsystems, including the MLBAD-based combinatorial optimization problem solver 122, which supports various functions and services with respect to various embodiments described herein. The application server 116 is communicatively coupled to a database server 118, which facilitates access to database(s) 120 that stores data associated with the MLBAD-based combinatorial optimization problem solver 122.

According to various embodiment, the MLBAD-based combinatorial optimization problem solver 122 accesses, or makes use of, a quantum computer-based solver 124 to perform one or more operations for determining a solution (e.g., a complete combinatorial solution) for a computational problem that comprises a combinatorial optimization problem. For instance, the MLBAD-based combinatorial optimization problem solver 122 can use quantum computer-based solver 124 to determine a solution for a computational problem that comprises a binary optimization problem (e.g., a quadratic unconstrained binary optimization (QUBO) problem). Depending on the embodiment, the MLBAD-based combinatorial optimization problem solver 122 can be implemented using (e.g., comprises) a quantum computer, such as a quantum annealer, or a universal gate quantum computer.

During operation, the MLBAD-based combinatorial optimization problem solver 122 can access a first computational problem comprising a combinatorial optimization problem. For instance, the first computational problem (e.g., data describing the first computational problem) can be submitted by one of the client devices 102 to the MLBAD-based combinatorial optimization problem solver 122 (e.g., by way of the API server 110 or the web server 112) for a solution. In response to the submission (or an instruction from the client device 102), the MLBAD-based combinatorial optimization problem solver 122 can access the first computational problem (e.g., the submitted data describing the first computational problem). The first computational problem can relate to, for example, a route optimization problem, an assignment problem, or a resource number and location optimization problem.

To determine a solution (e.g., close to optimal solution) for the first computational problem, the MLBAD-based combinatorial optimization problem solver 122 can perform (e.g., execute) one or more iterations of a branch-and-bound algorithm that uses a trained machine learning model as a branching policy, and one or more iterations of a diving algorithm that uses another trained machine learning model as a diving policy. For instance, the MLBAD-based combinatorial optimization problem solver 122 can perform (e.g., execute) a branch-and-bound algorithm to generate a branch-and-bound search tree of the first computational problem, and to identify a single node of the branch-and-bound search tree for further evaluation for determining a complete combinatorial solution for the first computational problem. The performance of the branch-and-bound algorithm can comprise using a first trained machine learning model as a branching policy for the branching algorithm. For instance, the first trained machine learning model can comprise a trained neural network. Additionally, the first trained machine learning model can be trained using (e.g., using training data generated during) performance (e.g., execution) of another branch-and-bound algorithm that uses full strong branch (FSB) as its branching policy, or some other known policy. As described herein, the branch-and-bound algorithm can be performed multiple times prior to moving to subsequent operations.

After performance of the one or more iterations of the branch-and-bound algorithm, the MLBAD-based combinatorial optimization problem solver 122 can determine a complete combinatorial solution for the first computational problem based on the branch-and-bound search tree (generated by the branch-and-bound algorithm). In particular, the MLBAD-based combinatorial optimization problem solver 122 can determine the complete combinatorial solution by performing an iteration that comprises: performing (e.g., executing) a diving algorithm on the branch-and-bound search tree, starting from the single node identified by the branch-and-bound algorithm (e.g., last iteration of the branch-and-bound algorithm), to determine a partial combinatorial solution for the first computational problem based on the identified single node; determining, based on the partial combinatorial solution, a second computational problem that comprises a unconstrained binary optimization problem (UBO) (e.g., transform the first computational problem to the second computational problem based on the partial combinatorial solution); determining an optimized solution for the second computational problem by using an external solver (e.g., the quantum computer-based solver 124); and determining the complete combinatorial solution based on the optimized solution and the partial combinatorial solution (e.g., combining together the optimized solution and the partial combinatorial solution and transform the resulting solution to the complete combinatorial solution). Additionally, performing the iteration can comprise: determining whether at least one diving criterion is satisfied for performing the iteration again; and in response to determining that the at least one diving criterion is satisfied, reperforming the iteration. Alternatively, in response to determining that the at least one diving criterion is not satisfied, the MLBAD-based combinatorial optimization problem solver 122 can determine whether at least one branching criterion is satisfied. In response determining that at least one branching criterion is not satisfied, the MLBAD-based combinatorial optimization problem solver 122 can provide (e.g., the client device 102) the complete combinatorial solution as a best-known solution to the first computational problem. However, in response determining that at least one branching criterion is satisfied, the MLBAD-based combinatorial optimization problem solver 122 can perform another iteration of the branch-and-bound algorithm to identify another single node of the branch-and-bound search tree for further evaluation for the complete combinatorial solution for the first computational problem.

For some embodiments, a global dual bound of an optimal solution for the first computational problem is determined during performance of the branch-and-bound algorithm, a global primal bound for the optimal solution is determined during performance of the diving algorithm, and the at least one diving criterion comprises a optimality gap value surpasses a predetermined threshold value, where the optimality gap value represents the difference between the global primal bound and the global dual bound. Additionally, or alternatively, the at least one diving criterion comprises at least one of an elapsed execution time (e.g., overall execution time by the MLBAD-based combinatorial optimization problem solver 122 to solve the first computational problem, or overall execution time for performing the iteration one or more times), or a number of times the iteration was performed by the MLBAD-based combinatorial optimization problem solver 122.

The MLBAD-based combinatorial optimization problem solver 122 can determine the complete combinatorial solution based on the optimized solution and the partial combinatorial solution by determining an intermediate binary solution by combining the optimized solution and the partial combinatorial solution; and determining the complete combinatorial solution based on the binary intermediate solution by converting (e.g., transforming) the binary intermediate solution to the complete combinatorial solution.

The performance of the diving algorithm can comprise using a second trained machine learning model (e.g., different from the first trained machine learning model) as a diving policy for the diving algorithm. The second trained machine learning model can comprise a trained neural network. The second trained machine learning model can comprise a generative model. Additionally, the second trained machine learning model can be trained using training data comprising a plurality of feasible solutions for combinatorial optimization problems considered during training. It may be too computationally expensive to generate all feasible solutions to even a single problem instance and, thus, for some embodiments, an existing solver for combinatorial optimization problems is used to generate many feasible solutions.

As described herein, the MLBAD-based combinatorial optimization problem solver 122 can determine the optimized solution for the second computational problem by using a solver. For instance, the MLBAD-based combinatorial optimization problem solver 122 can determine the optimized solution for the second computational problem by using the quantum computer-based solver 124 (e.g., implemented by a quantum annealer or a universal gate quantum computer), and can do so by converting (e.g., transforming) the second computational problem (that comprises a UBO) to a third computational problem that comprises a quadratic unconstrained binary optimization (QUBO) problem; and submitting the third computational problem to the quantum computer-based solver to generate the optimized solution. Alternatively, the solve used by the MLBAD-based combinatorial optimization problem solver 122 can be implemented using other computing technologies, such as digital annealing computer (e.g., digital annealer), a neuromorphic processor-based computer, a GPU-based computer, a high performance compute (HPC) computer, and the like.

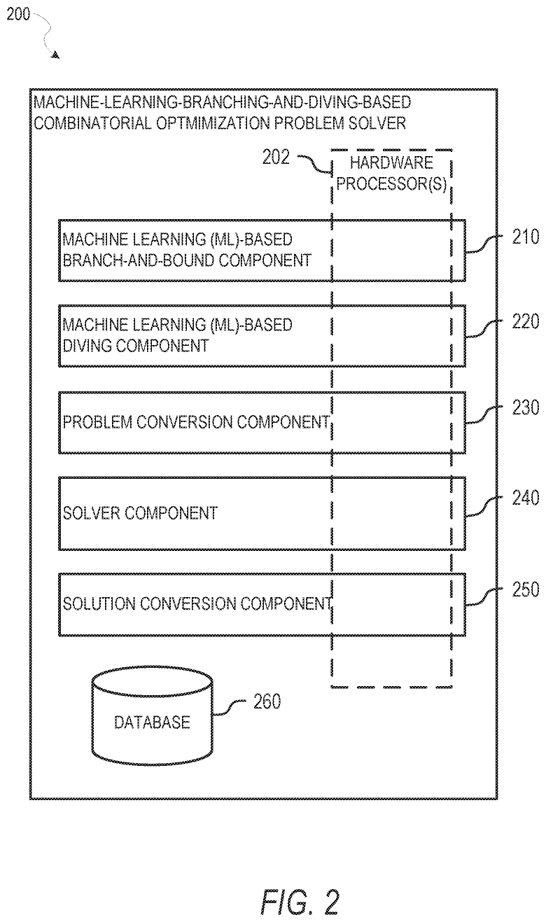

FIG. 2 is a block diagram illustrating an example neural-branching-and-diving-based combinatorial optimization problem solver 200, according to various embodiments of the present disclosure. For some embodiments, the neural-branching-and-diving-based combinatorial optimization problem solver 200 (hereafter, the MLBAD-based combinatorial optimization problem solver 200) represents an example of the MLBAD-based combinatorial optimization problem solver 122 described with respect to FIG. 1. As shown, the MLBAD-based combinatorial optimization problem solver 200 comprises a machine learning (ML)-based branch-and-bound component 210, a machine learning (ML)-based diving component 220, a problem conversion component 230, a solver component 240, and a solution conversion component 250. According to various embodiments, the ML-based branch-and-bound component 210 facilitates performance of one or more iterations of a branch-and-bound algorithm with respect to a computational optimization problem, the ML-based diving component 220 facilitates performance of one or more iterations of a diving algorithm with respect to a computational optimization problem, the problem conversion component 230 facilitates conversion (e.g., transformation) of a computational optimization problem comprising computational optimization problem to another computational optimization problem comprising a binary optimization problem (e.g., UBO or QUBO problem), the solver component 240 facilitate using a solver (e.g., the quantum computer-based solver 124) to determine a solution to a optimization problem (e.g., UBO or QUBO problem), and the solution conversion component 250 facilitate combining of solutions and converting of solutions (e.g., transforming a binary optimization solution to a combinatorial optimization solution). Data generated by one or more of the components 210 through 250 can be stored in a database 260 of the MLBAD-based combinatorial optimization problem solver 200.

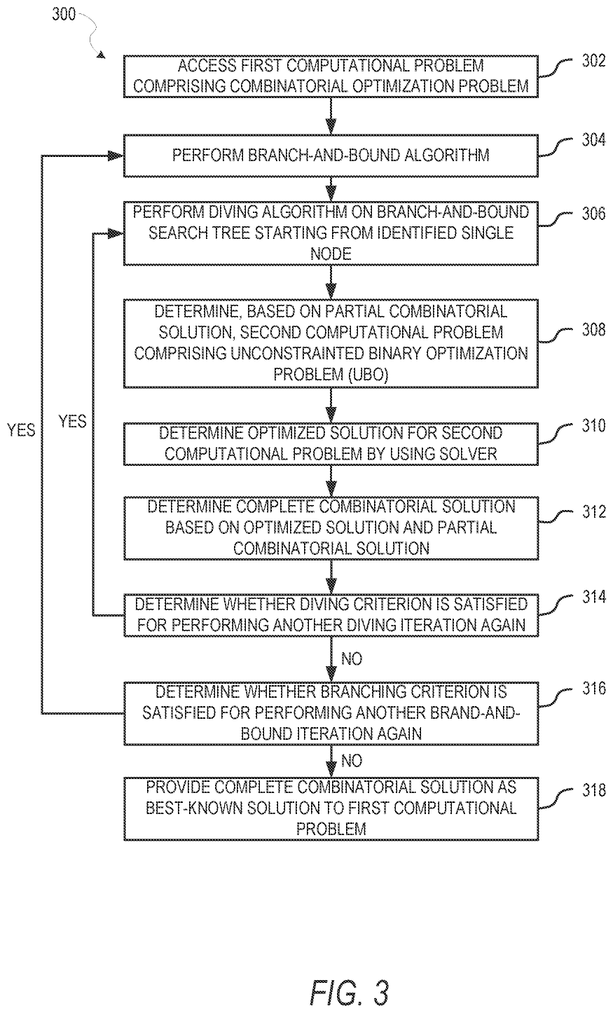

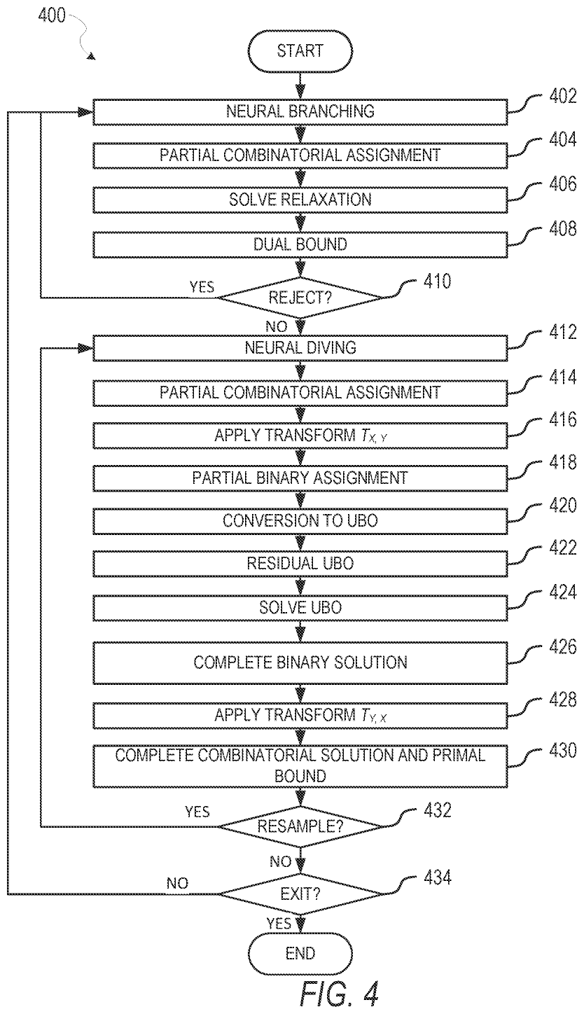

FIG. 3 through FIG. 4 are flowcharts illustrating example methods for a ML-based branching technique and a ML-based diving technique to solve a computational problem that comprises a combinatorial optimization problem, according to various embodiments of the present disclosure. It will be understood that example methods described herein may be performed by a machine in accordance with some embodiments. For example, method 300 or method 400 can be performed by the MLBAD-based combinatorial optimization problem solver 122 described with respect to FIG. 1, the MLBAD-based combinatorial optimization problem solver 200 described with respect to FIG. 2, or individual components thereof. An operation of various methods described herein may be performed by one or more hardware processors 202 (e.g., digital hardware processors, such as central processing units (CPUs) or graphics processing units (GPUs)) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 300 or method 400 may be represented by executable instructions that, when executed by a digital hardware processor of a computing device, cause the computing device to perform the method 300 or the method 400. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

Referring now to method 300 of FIG. 3, at operation 302, a digital hardware processor accesses a first computational problem comprising a combinatorial optimization problem. As described herein, data describing the first computational problem can be submitted (e.g., by a client device to solver of an embodiment) for a solution. In response to the submission, the digital hardware processor can perform operation 302. The first computational problem can relate to, for example, a route optimization problem, an assignment problem, or a resource number and a location optimization problem.

Thereafter, at operation 304, the digital hardware processor performs a branch-and-bound algorithm to generate a branch-and-bound search tree of the first computational problem and to identify a single node of the branch-and-bound search tree for further evaluation for determining a complete combinatorial solution for the first computational problem. For some embodiments, performance of the branch-and-bound algorithm comprises using a first trained machine learning model as a branching policy for the branching algorithm. For instance, the first trained machine learning model can comprise a trained neural network. Additionally, the first trained machine learning model can be trained using (e.g., using training data generated during) performance (e.g., execution) of another branch-and-bound algorithm that uses full strong branch (FSB) as its branching policy (or some other known policy). As described herein, the branch-and-bound algorithm can be performed multiple times prior to moving to subsequent operations.

According to various embodiments, the branch-and-bound algorithm comprises iteratively or recursively building the branch-and-bound search tree. The branch-and-bound search tree is used to divide the combinatorial optimization problem into smaller subproblems (represented by child nodes in the tree, and the partial solutions respectively associated with those child nodes), or branches, and solve each subproblem as best as possible. The resulting solutions to the subproblems can be used to determine (e.g., generate) dual bounds on the value of the optimal solution to the original combinatorial optimization problem. These dual bounds are used to prune the search space and avoid exploring subproblems that are guaranteed to be suboptimal.

Accordingly, one or more non-root (child) nodes in the branch-and-bound search tree can represent a partial solution to the combinatorial optimization problem with one independent variable, xᵢ, restricted to a subset of admissible values (i.e., values that do not violate any constraints). If the subset at a given node contains only one value, the given node can represent a subproblem that can be solved to determine (e.g., generate) a partial solution to the problem with xᵢ taking the one value. During an iteration of the branch-and-bound algorithm, a leaf node of the branch-and-bound search tree (i.e., a node in the branch-and-bound search tree which currently has no children) can be chosen (e.g., selected) to branch from based on a branching policy implemented by a trained machine learning model, the subproblem represented by the chosen node can be solved as best as possible to determine a partial solution, and a dual bound on an optimal solution of the combinatorial optimization problem can be determined based on the determined partial solution for the chosen node. Where the first combinatorial optimization problem is a minimization problem, this dual bound is a lower bound, and where the first combinatorial optimization problem is a maximization problem, this dual bound is an upper bound. The dual bound can provide a dual bound on the objective value of any further child nodes from the chosen node.

One of several techniques for determining (e.g., finding) a dual bound can be used. An example technique comprises a relaxation of the original combinatorial optimization problem into a related problem where each element in the solution vector x is no longer restricted to an integer and instead may take any real number value. This relaxed version of the combinatorial optimization problem can then be solved efficiently to determine (e.g., calculated) a dual bound to the original combinatorial optimization problem. If the determined (e.g., calculated) dual bound is less optimal than any known feasible solution to the combinatorial optimization problem, this indicates that no solutions better than a currently known solution can exist within the subtree of the chosen node and, as a result, the chosen node can be pruned from the branch-and-bound search tree since. However, if the determined (e.g., calculated) dual bound is not less optimal than any known feasible solution to the combinatorial optimization problem, the branch-and-bound algorithm can choose (e.g., select) another independent variable, xⱼ, that is not restricted to a single value and branches the chosen node into two child nodes (i.e., adds two new child nodes to the chosen node) based on a set R of values xⱼ that are currently restricted to: one where xⱼ is restricted to a proper subset of R and another where xⱼ is restricted to the remaining values in R. In this way, the branching process divides the subproblem represented by the chosen node into two smaller subproblems. The process of finding a dual bound for another node can then repeat, and the branch-and-bound algorithm can continue to iterate in this way until a sufficient number of branches (e.g., all branches) have been explored or pruned, or a solution which is sufficiently close to optimal is determined (e.g., found). Generally, the branch-and-bound algorithm's ability to generate tighter dual bounds on the value of the optimal solution for the combinatorial optimization problem, the fewer branches need to be explored, and the faster an embodiment can converge to the optimal solution.

For various embodiments, the branch-and-bound algorithm is guided by a machine learning (ML)-based branching policy (or ML-based branching algorithm) that determines how to select independent variables for evaluation, how to create subsets of restricted values for creating child nodes, or some combination of both. For instance, the ML-based branching policy can be implemented using (e.g., can comprise) a trained machine learning model. For example, with respect to a chosen node of the branch-and-bound search tree, a partial or empty solution associated with the chosen node can be provided as input to the trained machine learning model, and the trained machine learning model can output a predicted branching decision.

The trained machine learning model for the branch-and-bound algorithm can be trained based on example combinatorial optimization problems using a different branching policy algorithm. For instance, another branching policy algorithm is used to train (e.g., generate training data for training) the machine learning model that implement a ML-based branching policy used by the branch-and-bound algorithm. One example branching policy used can include one that minimizes the size of the tree required to reach a desired dual bound by making better branching decisions. Another example branching policy used can include a Full Strong Branching (FSB), which simulates one branching step for all candidate variables, then branches on the variable that provides the largest improvement in the lower-bound. An advantage of using a trained machine learning can significantly reduce computational costs as compared to a traditional policy, as the trained machine learning model can approximate the behavior of the traditional policy and the quality of this approximation can vary for different problem domains. The training data can comprise a set of labeled outputs that correspond to good branching choices in the branch-and-bound search tree, where this label data can be generated by a traditional policy (e.g., FSB). To mitigate this out-of-family problem, labels generated by the expert policy can be mixed with random choices, where this “fuzzing” can broaden the data evaluated by the traditional policy and can broaden the training data that results. For example, for each instance of an example combinatorial optimization problem, the branch-and-bound approach can be applied with a traditional policy (e.g., FSB) 90 percent of the time, while the remainder of the time, random branching decisions are used. Eventually, only the results of calls to the traditional policy can be used as training data.

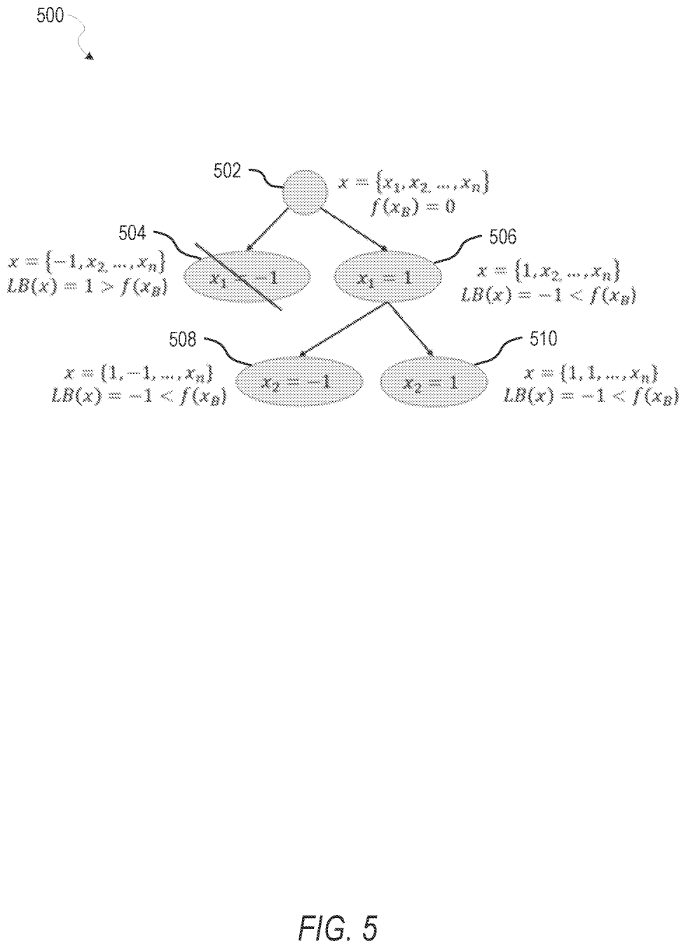

More regarding an example branch-and-bound search tree is described herein with respect to FIG. 5.

After operation 304, the digital hardware processor performs operations 306 through 314 to determine a complete combinatorial solution for the first computational problem based on the branch-and-bound search tree (generated by the branch-and-bound algorithm). In particular, at operation 306, the digital hardware processor performs a diving algorithm on the branch-and-bound search tree starting from the identified single node (identified by the branch-and-bound algorithm during operation 304), where the diving algorithm determines a partial combinatorial solution for the first computational problem based on the identified single node, and where the diving algorithm uses a second trained machine learning model as a diving policy for the diving algorithm.

According to various embodiments, a diving algorithm (e.g., a diving heuristic) serves as a counterpart to the branch-and-bound algorithm, and performs an exploration (e.g., depth-first exploration) of the branch-and-bound search tree to identify near-optimal solutions of the combinatorial optimization problem starting from the single node identified by operation 306. The diving algorithm can be used to solve the combinatorial optimization problem (starting with the partial combinatorial solution associated with the identified single node) by dividing the solution space for the combinatorial optimization solution into regions (or dives) that can be explored one by one. For some embodiments, while determining a partial combinatorial solution for the combinatorial optimization problem (based on the identified single node), the diving algorithm determines (e.g., finds) a primal bound (e.g., to the optimal value) of the objective function of the combinatorial optimization problem. Where the first combinatorial optimization problem is a minimization problem, this primal bound is an upper bound, and where the first combinatorial optimization problem is a maximization problem, this primal bound is a lower bound.

For some embodiments, the diving algorithm starts from the identified single node in the branch-and-bound tree and sequentially assigns each unassigned independent variable to a fixed value until either a leaf node is reached (indicating that a complete solution vector has been determined) or the assignment is deemed infeasible or sub-optimal. An infeasible vector can be one that violates the constraints of the combinatorial optimization problem, and a sub-optimal solution can comprise a solution that results in a worse objective score than any already known solution. Alternatively, the diving algorithm implements a neighborhood search, where the diving algorithm starts from the identified single node in the branch-and-bound tree, sequentially assigns each unassigned independent variable to a fixed value until a partial solution is determined, and then uses a solver (e.g., quantum computer-based solver 124) to complete the solution or demonstrate it is infeasible to complete the solution.

For various embodiments, the diving algorithm uses a trained machine learning model as a diving policy (e.g., diving algorithm) to determine suggested partial assignment of values to partial solutions associated with nodes of the branch-and-bound search tree. The trained machine learning model can approximate a distribution using a generative model, which can represent reduced computational cost compared with traditional diving techniques at the expense of approximation error. For example, a partial or empty solution associated with the current node can be provided as input to the trained machine learning model, and the trained machine learning model can output a predicted partial solution different from the input. For some embodiments, the trained machine learning model comprises a generative model, and the training data used to train the trained machine learning can include several feasible solutions for each problem instance considered. An existing solver can be used for each of the combinatorial optimization problems to generate the several feasible solutions.

At operation 308, the digital hardware processor determines, based on the partial combinatorial solution determined by the diving algorithm at operation 306, a second computational problem that comprises a unconstrained binary optimization problem (UBO). According to some embodiments, based on partial value assignments made during the neural branching and diving process (to generate the partial combinatorial solution), the digital hardware processor converts (e.g., transfers) the remaining sub-problem to a pseudo-Boolean optimization problem (e.g., of the form shown in Equation 2). In doing so, various embodiments provide a starting point for converting the combinatorial optimization problem to a form a unconstrained binary optimization (UBO) problem. Depending on the embodiment, any process of converting from a pseudo-Boolean optimization problem to such a form is acceptable as long as optimal solutions to the UBO problem match those from the original form.

For example, one method for converting the pseudo-Boolean optimization problem (e.g., in the form of Equation 2) to a UBO problem can comprise using constraint relaxation, slack variables, and degree reduction. While the first two of these are concerned with converting to a problem form that does not involve constraints, the last (degree reduction) is concerned with converting to a problem form that only includes linear and quadratic terms and is optional for the conversion to a UBO problem.

For constraint relaxation, For each equality constraint of the form Σ_{I⊆{1,2, . . . ,m}}αₗΠ_{i∈l}yᵢ=c, we can remove the constraint and add the “beta term” β(Σ_{I⊆{1,2, . . . ,m}}αₗΠ_{i∈l}yᵢ−c)² to the objective function. Doing this with all equality constraints transforms Equation 2 into the form of Equation 4, as follows:

$${min}_{y} {\sum }_{I ⊆ \{ 1 , 2 , … , m \}} {α}_{I} {\prod }_{i ∈ I} {y}_{i} + β {\sum }_{j = 1}^{{k}_{=}} {( {\sum }_{I ⊆ \{ 1 , 2 , … , m \}} {α}_{I}^{j , =} {\prod }_{i ∈ I} {y}_{i} - {c}_{j}^{=} )}^{2}$$

$$subject to y ∈ {\{ 0 , 1 \}}^{m} ,$$

$${\sum }_{I ⊆ \{ 1 , 2 , … , m \}} {α}_{I}^{j , =} {\prod }_{i ∈ I} {y}_{i} \leq {c}_{j}^{\leq } for j ∈ \{ 1 , 2 , … , {k}_{\leq } \}$$

For each equality constraint that is satisfied by a solution y, the corresponding beta term evaluated at y is zero. β can be seen as a scale factor for penalizing constraint violations. In general, if β is large enough, then the optimum solution to a problem in the form of Equation 4 satisfies the constraints of Equation 2. Moreover, the value of the objective function for each problem can be the same in such cases. Generally, this conversion process is referred to as constraint relaxation because a hard constraint is “relaxed” into a penalty for violating the constraint.

With respect to slack variables, for each equality constraint of the form Σ_{I⊆{1,2, . . . ,m}}αₗΠ_{i∈l}yᵢ≤c, a so-called slack variable can be introduced in order to convert this constraint into an equality constraint and a zero-bounded inequality constraint. Let y* be the slack variable for this constraint. The new constraints can then be y*≥0 and y*+Σ_{I⊆{1,2, . . . ,m}}αₗΠ_{i∈l}yᵢ=c.

Next, these constraints are removed and replace with beta terms, as before. Since y* is not a binary variable, to convert it to binary variables, the maximum value y* can be determined. The resulting value can be

$$c - {min}_{y} {\sum }_{I ⊆ \{ 1 , 2 , … , m \}} {α}_{I} {\prod }_{i ∈ I} {y}_{i} .$$

As a result, y* can now be represented as <2, α>, where α is a vector of

$${m}^{*} = ⌈ {log}_{2} ( c - {min}_{y} {\sum }_{I ⊆ \{ 1 , 2 , … , m \}} {α}_{I} {\prod }_{i ∈ I} {y}_{i} ) ⌉$$

new binary variables, 2 is a vector of powers of 2 the same length as α, and <2, α> is the inner product of 2 and α. This representation can allows permit an embodiment to enforce the constraint with the beta term (Σ_{I⊆{1,2, . . . ,m}}αₗΠ_{i∈l}yᵢ−c)². Doing this with all equality constraints transforms into the form of Equation 5, as follows:

$${min}_{y} {\sum }_{I ⊆ \{ 1 , 2 , … , m \}} {α}_{I} {\prod }_{i ∈ I} {y}_{i} + β {\sum }_{j = 1}^{{k}_{=}} {( {\sum }_{I ⊆ \{ 1 , 2 , … , m \}} {α}_{I}^{j , =} {\prod }_{i ∈ I} {y}_{i} - {c}_{j}^{=} )}^{2} + β {\sum }_{j = 1}^{{k}_{\leq }} {( {\sum }_{I ⊆ \{ 1 , 2 , … , m \}} {α}_{I}^{j , \leq } {\prod }_{i ∈ I} {y}_{i} + 〈 2 , {a}_{j} 〉 - {c}_{j}^{\leq } )}^{2}$$

$$subject to y ∈ {\{ 0 , 1 \}}^{m} , {a}_{j} ∈ {\{ 0 , 1 \}}^{{m}_{j}} for j ∈ \{ 1 , 2 , … , {k}_{\leq } \}$$

This result is a problem in UBO form, where the pseudo-Boolean optimization problem has been converted to be without any constraints.

At operation 310, the digital hardware processor determines an optimized solution for the second computational problem by using a quantum computer-based solver. For some embodiments, operation 310 comprises using a solver to determine the optimized solution for the second computational problem. For instance, a quantum computer-based solver can be used to determine the optimized solution for the second computational problem, and can do so by submitting the second computational problem to the quantum computer-based solver to generate the optimized solution (which can be returned to the digital hardware processor).

Depending on the embodiment, the UBO problem (in the form of Equation 5) can be solved using one or more various techniques (e.g., implemented by a solver, such quantum computer-based solver 124) that use different computing technologies, such as quantum annealing, quantum circuit model, one-way quantum computing, neuromorphic computing, and traditional computing. For instance, an embodiment can use a quantum computer-based solver (e.g., 124) to solve the UBO by mapping variables of the UBO problem to physical qubit circuits of the quantum computer-based solver.

Where the quantum computer-based solver used is implemented by certain type quantum computers, such as a quantum annealer, the mapping process can comprise a process called minor embedding. Generally, the embedding constraints can depend on the specific qubit topology of the quantum computer implementing the solver. After minor embedding the UBO problem to the available qubit topology, the quantum computer of the solver can be used to solve the UBO problem. This can occur in three phases. In a first phase, the inputs are prepared. In a second phase, the quantum computer execution process runs (e.g., quantum annealing is performed). Finally, the resulting quantum state of one or more qubits are measured. The probabilistic nature of quantum computer execution processes, (e.g., quantum annealing) means that there is no guarantee that the measurement will correspond to a global minimum of the UBO problem. Accordingly, to mitigate this probabilistic nature, the quantum computer process (e.g., quantum annealing) can be performed many times on the same input. For some embodiments, the input preparation only needs to be performed once to perform multiple iterations of running the quantum computer execution process (e.g., quantum annealing) and measuring the quantum state of the one or more qubits. A result can comprise a list of feasible solutions to the UBO problem, each associated with an energy of the measured quantum state. The energy associated with a feasible solution corresponds to the result of evaluating the objective function on the solution.

To solve the UBO problem using certain optimization solving techniques, such as a quantum computer-based solver implemented by a quantum annealer, some embodiments convert the UBO problem prior to submitting the UBO problem to the quantum computer-based solver. For instance, operation 310 can comprise: converting (e.g., transforming) the second computational problem (that comprises a UBO problem) to a third computational problem that comprises a quadratic unconstrained binary optimization (QUBO) problem; and submitting the third computational problem to the quantum computer-based solver to generate the optimized solution. Some embodiments convert (e.g., transform) the UBO problem to a problem in quadratic unconstrained binary optimization (QUBO) form, as shown in Equation 6, where x is a vector of binary variables, each wᵢ is a weight associated with a variable, and each w_{i,j} is a weight associated with a pair of variables. Equation 6:

$${min}_{x} {\sum }_{i} {w}_{i} {x}_{i} + {\sum }_{j > i} {w}_{i , j} {x}_{i} {x}_{j}$$

$$subject to x ∈ {\{ 0 , 1 \}}^{n}$$

One of several any degree reduction techniques can be used to convert a UBO problem in the form of Equation 5 to a QUBO problem in the form of Equation 6. For instance, an embodiment can use both the Freedman and Ishikawa methods as a degree reduction technique. Generally, the Freedman method applies to negative monomial terms of a pseudo-Boolean function (i.e., terms of the polynomial with a negative coefficient). This method is based on the observation given in Equation 7, where d is the degree of the monomial term. Equation 7:

$$- {\prod }_{n = 1}^{d} {u}_{n} = {min}_{v ∈ \{ 0 , 1 \}} v ( ( d - 1 ) - {\sum }_{n = 1}^{d} {u}_{n} )$$

By applying this substitution to each super-quadratic, negative, monomial term in the pseudo-Boolean objective function, an embodiment can ensure all remaining super-quadratic terms in the objective function are positive monomials. This adds one additional Boolean variable (variable v) to the optimization problem for each substitution applied.

The Ishikawa method applies to positive monomial terms of a pseudo-Boolean function; that is, terms of the polynomial with a positive coefficient. This method is based on the observation given in Equation 8, where d is the degree of the monomial term,

$$k = ⌊ \frac{d - 1}{2} ⌋ ,$$

and the wₙ are k new Boolean variables. Equation 8:

$${\prod }_{n = 1}^{d} {u}_{n} = \{ \begin{matrix}{S}_{2} + {min}_{w ∈ {\{ 0 , 1 \}}^{k}} \{ {W}_{2} - 2 {W}_{1} {S}_{1} \} , & if d is even \\ {S}_{2} + {min}_{w ∈ {\{ 0 , 1 \}}^{k}} \{ {W}_{2} - 2 {W}_{1} {S}_{1} + {w}_{k} ( {S}_{1} - d + 1 ) \} , & if d is odd\end{matrix}$$

$$where ,$$

$${S}_{1} = {\sum }_{n = 1}^{d} {u}_{n} , {S}_{2} = {\sum }_{1 \leq n < m \leq d} {u}_{n} {u}_{m} , {W}_{1} = {\sum }_{n = 1}^{k} {w}_{k} , and {W}_{2} = {\sum }_{n = 1}^{k} ( 4 n - 1 ) {w}_{n}$$

By applying this substitution to each super-quadratic, positive, monomial term in the pseudo-Boolean objective function, an embodiment can ensure all remaining terms in the objective function are linear or quadratic terms. This adds k additional Boolean variables (variables wₙ) to the optimization problem for each substitution applied.

After an embodiment applies both the Freedman and Ishikawa substitutions are to the super-quadratic terms of a UBO problem, a QUBO problem in the form of Equation 6 results. Any additional techniques for further reducing the degree or number of variables in the optimization problem can be applied by an embodiment at this point, if desired.

At operation 312, the digital hardware processor determines the complete combinatorial solution based on the optimized solution and the partial combinatorial solution. For instance, operation 312 can comprise determining an intermediate binary solution by combining the optimized solution and the partial combinatorial solution, and determining the complete combinatorial solution based on the binary intermediate solution by converting (e.g., transforming) the binary intermediate solution to the complete combinatorial solution.

For some embodiments, branch-and-bound and diving are complimentary techniques that are being combined into a joint solver. In particular, the branch-and-bound technique can first produce one or more branching steps until some threshold number of viable nodes are obtained. Subsequently, the diving technique can be applied to each viable node to produce one or more suggested partial assignments from each node. Thereafter, a suitable optimization solver (e.g., quantum computer-based solver) can be applied to the resulting sub-problem to generate complete (but not necessarily optimal) optimization solutions. During this process, a global primal bound (e.g., minimum objective score of any known solution) and a global dual bound (e.g., maximum dual bound of all nodes in the tree) can be maintained. This primal-dual gap is then defined by Equation 9 and can provide a bound on how optimal the current best-known solution is. Additionally, the primal-dual gap can be normalized in various ways to produce a relative gap. Equation 9:

primal-dual gap=global primal bound−global dual bound

The joint branch-and-dive algorithm can terminate when a suitable stopping criterion is reached. Common examples of such stopping criteria include (1) the relative gap is below some application-specific threshold and (2) a time limit is reached.

Accordingly, at operation 314, the digital hardware processor determines whether at least one diving criterion is satisfied for performing the iteration again. For some embodiments, a global dual bound of an optimal solution for the first computational problem is determined during performance of the branch-and-bound algorithm (operation 304), a global primal bound for the optimal solution is determined during performance of the diving algorithm (operation 306), and the at least one diving criterion (e.g., application-specific threshold) comprises a relative gap value surpasses a predetermined threshold value, where the objective gap value representing a gap between the global primal bound and the global dual bound. For some embodiments, the at least one diving criterion comprises at least one of an elapsed execution time. Additionally, for some embodiments, a number of times the iteration was performed.

In response to determining that the at least one diving criterion is satisfied, the method 300 returns to operation 306 to perform another iteration of the diving algorithm. However, in response to determining that the at least one diving criterion is not satisfied, the method 300 proceeds to operation 316. At operation 316, the digital hardware processor determines whether at least one branching criterion is satisfied. Operation 316 can represent evaluating one or more stopping conditions for iterative exploration of the solution space of the combinatorial optimization problem. In response determining that at least one branching criterion is not satisfied, the method 300 proceeds to operation 318, where the digital hardware processor provides the complete combinatorial solution as a best-known solution to the first computational problem. However, in response determining that at least one branching criterion is satisfied, the method 300 returns to operation 304 to perform another iteration of the branch-and-bound algorithm.

Referring now to method 400 of FIG. 4, the method 400 is an example implementation of the method 300 of FIG. 3. At the start, a digital hardware processor performs a bound-and-branch algorithm by performing operations 402 through 408, which represents an iteration of the bound-and-branch algorithm. At operation 402, the digital hardware processor performs the neural branching using an approximation to a policy (as determined by a trained machine learning model) to build a branch-and-bound search tree. In particular, the branch-and-bound search tree can be built by starting a root node of the branch-and-bound search tree, selecting a node of the branch-and-bound search tree (by operation 402), selecting a variable (by operation 402), dividing the assignment options for the selected variable (at operation 404) into two sets (e.g., branches of the branch-and-bound search tree that form child nodes of the selected node) that are mutually exclusive and exhaustive, and selecting one of the two child nodes to explore. This selection of a child node can be a partial combinatorial assignment in that it assigns a value to a variable (e.g., where the assignment options associated with this child node include only one option) or partially assigns a value to a variable (e.g., where the assignment options associated with this child node include multiple options) while leaving remaining variables unchanged. Subsequent iterations can be similar with the exception that the starting node can be chosen from any node in the tree that has not been eliminated from the search.

At operation 406, the digital hardware processor performs solve relaxation step by: taking a node of the search tree selected (by operation 402); constraining the optimization problem of the parent node of the selected node to options associated with the selected node (thereby associating the new optimization problem with the selected node of the search tree); and determining a dual bound (at operation 408) for the new optimization problem (e.g., determine dual bound for the optimization problem associated with the selected node).

At operation 410, the digital hardware processor performs a test for rejecting by comparing the dual bound found (by operation 408) to a currently best known solution. If the dual bound is worse than the currently known solution, then the node can be eliminated (e.g., pruned) from the branch-and-bound search tree and operation 402 can be performed again starting from another node. Otherwise, the node can further explored via a diving algorithm.

In FIG. 4, the digital hardware processor performs the diving algorithm on the selected node by performing operations 412 and 414. In particular, starting from the reduced version of the combinatorial optimization problem at the currently selected node, the diving algorithm can be applied to determine (e.g., create) a partial combinatorial solution. At operation 412, the digital hardware processor uses an approximation to a policy (determined by a trained machine learning model) to determine (e.g., create) a partial assignment (at operation 414) to the optimization problem associated with the current selected node. For various embodiments, the trained machine learning model used for neural diving is different from the trained machine learning model used for neural branching.

Subsequently, the digital hardware processor uses (at operation 416) a function T_{xy} from Equation 3 to form a (possibly constrained) binary optimization problem from the combinatorial optimization problem associated with the current node, including conversion of any partial solutions from the operation 412 to binary form. In particular, the digital hardware processor uses the function T_{xy} (at operation 418) to form a partial binary solution to (represented by a partial binary assignment) this binary optimization problem from the partial solution to the combinatorial optimization problem associated with the current node, and then constrains the binary optimization problem to the partial solution to this binary optimization problem.

At operation 420, the digital hardware processor converts the (possibly constrained) binary optimization problem associated with the current node to a UBO problem. As described herein, an example method to perform this conversion is constraint relaxation with slack variables. Another example method, in the case the binary optimization problem is not constrained, is to associate the binary optimization with the current node as the UBO for this node. At operation 422, the conversion results as a residual UBO problem.

At operation 424, the digital hardware processor solves (e.g., optimizes) the UBO problem (e.g., residual UBO problem) by determining (e.g., generating) a solution of the UBO problem associated with the current node. Example methods of determining such a solution include submitting the UBO problem to a separate solver, such as a quantum computer-based solver (e.g., 124). Some example methods can comprise the UBO problem to be further converted prior to submission to the separate solver, such as converting the UBO problem to a QUBO problem.

At operation 426, the digital hardware processor determines (e.g., generates) a complete binary solution the solution generated by operation 424 with the partial solution to the binary optimization problem by operation 416.

At operation 428, the digital hardware processor converts the complete binary solution back to a complete combinatorial solution by applying a function Tyx (from Equation 3) to the complete binary solution. At operation 430, the complete combinatorial solution is stored for later use, and the combinatorial optimization problem's objective function is evaluated on the complete combinatorial solution to determine is the primal bound for the combinatorial optimization problem.

At operation 432, the digital hardware processor performs a resampling by evaluating one or more conditions for entering another iteration of the diving algorithm based on the complete combinatorial solution, the primal bound, or both. If the one or more conditions are satisfied, the method 400 returns to operation 412 for the diving algorithm to be reperformed on the current node, otherwise, the method 400 proceeds to operation 434.

At operation 434, the digital hardware processor tests for exiting the outer iterative loop of the method 400 and ending execution of the method 400. During operation 434, the digital hardware processor evaluates one or more exit conditions (for iterative exploration of the solution space of the combinatorial optimization problem). If the one or more conditions are satisfied, the method 400 ends, otherwise the method 400 returns to operation 402 to reperform the branch-and-bound algorithm on the branch-and-bound search tree.

FIG. 5 illustrates an example application of a branch-and-bound algorithm to generate an example branch-and-bound tree 500, according to various embodiments of the present disclosure. For simplicity of explanation, the illustrated example considers a binary optimization problem, however the technique can be generalized to combinatorial optimization problems. In this example, the algorithm starts at node 502 with an unassigned solution vector (x), the currently best-known solution to the problem (x_{B}), and a function that returns the objective value of any solution vector (ƒ). In this case, each independent variable, xᵢ, can be assigned either −1 or 1 and the objective value of the best-known solution, ƒ(x_{B}), is zero.

In the first iteration of the branch-and-bound algorithm, independent variable xᵢ is selected for consideration. From the root node 502 of the tree, two branches (represented by nodes 504 and 506) are created where xᵢ is assigned either −1 or 1. A dual bound is calculated for each branch represented by the function LB(x). In this example, the branch where x₁=−1 (node 504) produces a dual bound that is greater than the currently best-known solution, and thus this branch can be eliminated from consideration (e.g., pruned from the branch-and-bound search tree 500). The dual bound for the x₁=1 branch (node 506) is less than the currently best-known solution, so all potential solutions which are more optimal than the currently best-known solution must have x₁=1. The process repeats from node 506 for independent variable x₂ where the dual bound of both branches (nodes 508 and 510) is less than the best-known solution, and thus neither branch is eliminated from the branch-and-bound search tree 500. While only two steps are shown in this example, it will be understood that the branch-and-bound algorithm can continue until partial assignments with sufficiently few unassigned variables remain.

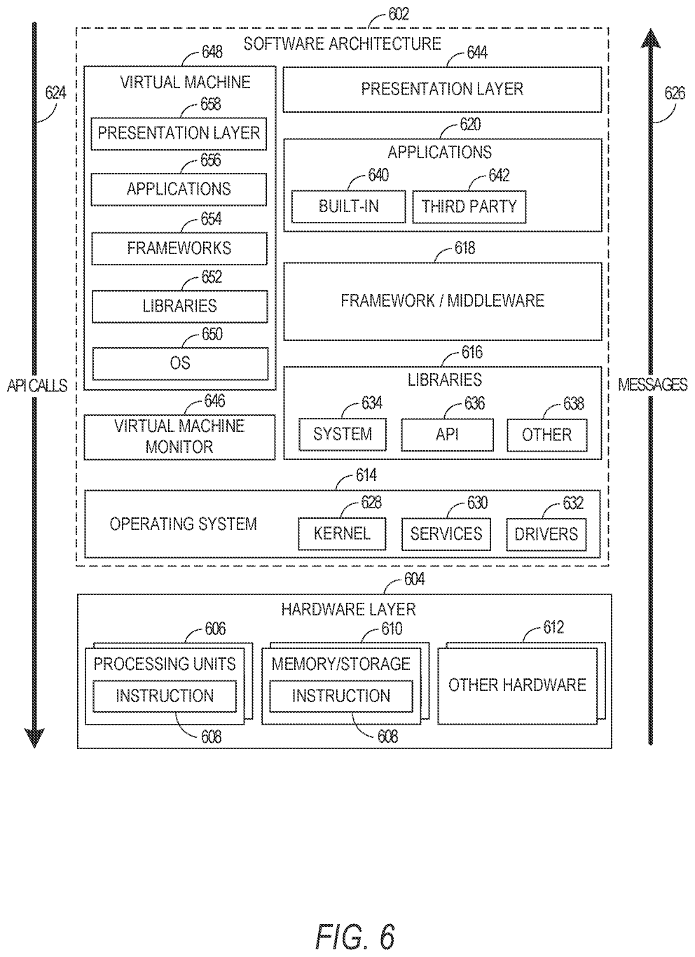

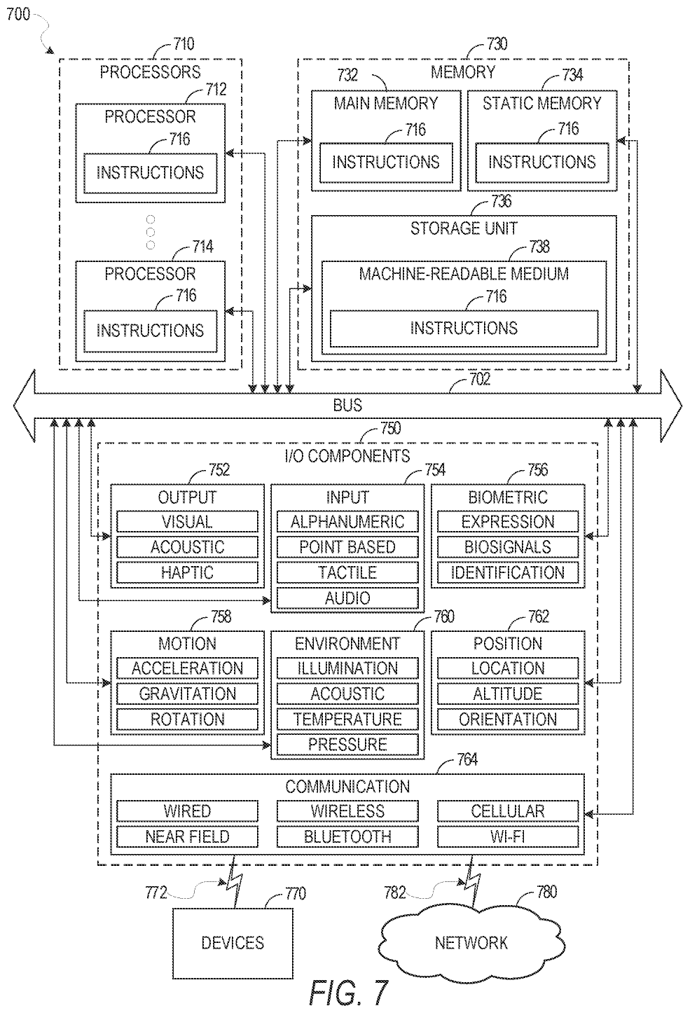

FIG. 6 is a block diagram illustrating an example of a software architecture 602 that may be installed on a machine, according to some example embodiments. FIG. 6 is merely a non-limiting example of software architecture, and it will be appreciated that many other architectures may be implemented to facilitate the functionality described herein. The software architecture 602 may be executing on hardware such as a machine 700 of FIG. 7 that includes, among other things, processors 710, memory 730, and input/output (I/O) components 750. A representative hardware layer 604 is illustrated and can represent, for example, the machine 700 of FIG. 7. The representative hardware layer 604 comprises one or more processing units 606 having associated executable instructions 608. The executable instructions 608 represent the executable instructions of the software architecture 602. The hardware layer 604 also includes memory or storage modules 610, which also have the executable instructions 608. The hardware layer 604 may also comprise other hardware 612, which represents any other hardware of the hardware layer 604, such as the other hardware illustrated as part of the machine 700.

In the example architecture of FIG. 6, the software architecture 602 may be conceptualized as a stack of layers, where each layer provides particular functionality. For example, the software architecture 602 may include layers such as an operating system 614, libraries 616, frameworks/middleware 618, applications 620, and a presentation layer 644. Operationally, the applications 620 or other components within the layers may invoke API calls 624 through the software stack and receive a response, returned values, and so forth (illustrated as messages 626) in response to the API calls 624. The layers illustrated are representative in nature, and not all software architectures have all layers. For example, some mobile or special-purpose operating systems may not provide a frameworks/middleware 618 layer, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. The drivers 632 may be responsible for controlling or interfacing with the underlying hardware. For instance, the drivers 632 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 616 may provide a common infrastructure that may be utilized by the applications 620 and/or other components and/or layers. The libraries 616 typically provide functionality that allows other software modules to perform tasks in an easier fashion than by interfacing directly with the underlying operating system 614 functionality (e.g., kernel 628, services 630, or drivers 632). The libraries 616 may include system libraries 634 (e.g., C standard library) that may provide functions such as memory allocation functions, string manipulation functions, mathematic functions, and the like. In addition, the libraries 616 may include API libraries 636 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 620 and other software components/modules.

The frameworks 618 (also sometimes referred to as middleware) may provide a higher-level common infrastructure that may be utilized by the applications 620 or other software components/modules. For example, the frameworks 618 may provide various graphical user interface functions, high-level resource management, high-level location services, and so forth. The frameworks 618 may provide a broad spectrum of other APIs that may be utilized by the applications 620 and/or other software components/modules, some of which may be specific to a particular operating system or platform.

The applications 620 include built-in applications 640 and/or third-party applications 642. Examples of representative built-in applications 640 may include, but are not limited to, a home application, a contacts application, a browser application, a book reader application, a location application, a media application, a messaging application, or a game application.

The third-party applications 642 may include any of the built-in applications 640, as well as a broad assortment of other applications. In a specific example, the third-party applications 642 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 642 may invoke the API calls 624 provided by the mobile operating system such as the operating system 614 to facilitate functionality described herein.

The applications 620 may utilize built-in operating system functions (e.g., kernel 628, services 630, or drivers 632), libraries (e.g., system libraries 634, API libraries 636, and other libraries 638), or frameworks/middleware 618 to create user interfaces to interact with users of the system. Alternatively, or additionally, in some systems, interactions with a user may occur through a presentation layer, such as the presentation layer 644. In these systems, the application/module “logic” can be separated from the aspects of the application/module that interact with the user.

Some software architectures utilize virtual machines. In the example of FIG. 6, this is illustrated by a virtual machine 648. The virtual machine 648 creates a software environment where applications/modules can execute as if they were executing on a hardware machine (e.g., the machine 700 of FIG. 7). The virtual machine 648 is hosted by a host operating system (e.g., the operating system 614) and typically, although not always, has a virtual machine monitor 646, which manages the operation of the virtual machine 648 as well as the interface with the host operating system (e.g., the operating system 614). A software architecture executes within the virtual machine 648, such as an operating system 650, libraries 652, frameworks/middleware 654, applications 656, or a presentation layer 658. These layers of software architecture executing within the virtual machine 648 can be the same as corresponding layers previously described or may be different.

FIG. 7 illustrates a diagrammatic representation of a machine 700 in the form of a computer system within which a set of instructions may be executed for causing the machine 700 to perform any one or more of the methodologies discussed herein, according to an embodiment. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example, the instructions 716 may cause the machine 700 to execute the method 300 described above with respect to FIG. 3 or the method 400 described above with respect to FIG. 4. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other such as via a bus 702. In an embodiment, the processors 710 (e.g., a digital hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 712 and a processor 714 that may execute the instructions 716. The term “processor” is intended to include multi-core processors that may comprise two or more independent processors (sometimes referred to as “cores”) that may execute instructions contemporaneously. Although FIG. 7 shows multiple processors 710, the machine 700 may include a single processor with a single core, a single processor with multiple cores (e.g., a multi-core processor), multiple processors with a single core, multiple processors with multiples cores, or any combination thereof.

The memory 730 may include a main memory 732, a static memory 734, and a storage unit 736 including machine-readable medium 738, each accessible to the processors 710 such as via the bus 702. The main memory 732, the static memory 734, and the storage unit 736 store the instructions 716 embodying any one or more of the methodologies or functions described herein. The instructions 716 may also reside, completely or partially, within the main memory 732, within the static memory 734, within the storage unit 736, within at least one of the processors 710 (e.g., within the processor's cache memory), or any suitable combination thereof, during execution thereof by the machine 700.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion, and the grouping is in no way limiting. In various embodiments, the I/O components 750 may include output components 752 and input components 754. The output components 752 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 750 may include biometric components 756, motion components 758, environmental components 760, or position components 762, among a wide array of other components. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 762 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772, respectively. For example, the communication components 764 may include a network interface component or another suitable device to interface with the network 780. In further examples, the communication components 764 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a USB).

Moreover, the communication components 764 may detect identifiers or include components operable to detect identifiers. For example, the communication components 764 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

Certain embodiments are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In some embodiments, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors (e.g., digital hardware processors) that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 700 including processors 710), with these operations being accessible via a network (e.g., the Internet) and via one or more appropriate interfaces (e.g., an API). In certain embodiments, for example, a client device may relay or operate in communication with cloud computing systems, and may access circuit design information in a cloud environment.

The performance of certain of the operations may be distributed among the processors, not only residing within a single machine 700, but deployed across a number of machines 700. In some example embodiments, the processors 710 or processor-implemented modules are located in a single geographic location (e.g., within a home environment, an office environment, or a server farm). In other example embodiments, the processors or processor-implemented modules are distributed across a number of geographic locations.

### Executable Instructions and Machine Storage Medium

The various memories (i.e., 730, 732, 734, and/or the memory of the processor(s) 710) and/or the storage unit 736 may store one or more sets of instructions 716 and data structures (e.g., software) embodying or utilized by any one or more of the methodologies or functions described herein. These instructions (e.g., the instructions 716), when executed by the processor(s) 710, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 716 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various embodiments, one or more portions of the network 780 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 770. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” “without limitation” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A system comprising:
a memory storing instructions; and
one or more digital hardware processors communicatively coupled to the memory and configured by the instructions to perform operations comprising:
accessing a first computational problem comprising a combinatorial optimization problem;
performing a branch-and-bound algorithm to generate a branch-and-bound search tree of the first computational problem and to identify a single node of the branch-and-bound search tree for further evaluation for determining a complete combinatorial solution for the first computational problem, the performing of the branch-and-bound algorithm comprising using a first trained machine learning model as a branching policy for the branching algorithm; and
determining the complete combinatorial solution for the first computational problem based on the branch-and-bound search tree, the determining of the complete combinatorial solution comprising performing an iteration that comprises:
performing a diving algorithm on the branch-and-bound search tree starting from the identified single node, the diving algorithm being configured to determine a partial combinatorial solution for the first computational problem based on the identified single node, the performing of the diving algorithm comprising using a second trained machine learning model as a diving policy for the diving algorithm;
determining, based on the partial combinatorial solution, a second computational problem that comprises a unconstrained binary optimization problem (UBO);
determining an optimized solution for the second computational problem by using a quantum computer-based solver; and
determining the complete combinatorial solution based on the optimized solution and the partial combinatorial solution.

2. The system of claim 1, wherein the determining of the complete combinatorial solution based on the optimized solution and the partial combinatorial solution comprises:
determining an intermediate binary solution by combining the optimized solution and the partial combinatorial solution; and
determining the complete combinatorial solution based on the binary intermediate solution by converting the binary intermediate solution to the complete combinatorial solution.

3. The system of claim 1, wherein the iteration comprises:
determining whether at least one diving criterion is satisfied for performing the iteration again; and
in response to determining that the at least one diving criterion is satisfied, reperforming the iteration.

4. The system of claim 3, wherein a global dual bound of an optimal solution for the first computational problem is determined during performance of the branch-and-bound algorithm, wherein a global primal bound for the optimal solution is determined during performance of the diving algorithm, and wherein the at least one diving criterion comprises a relative gap value surpasses a predetermined threshold value, the relative gap value representing a gap between the global primal bound and the global dual bound.

5. The system of claim 3, wherein the at least one diving criterion comprises at least one of an elapsed execution time, or a number of times the iteration was performed.

6. The system of claim 3, wherein the operations comprise:
in response to determining that the at least one diving criterion is not satisfied:
determining whether at least one branching criterion is satisfied; and
in response determining that at least one branching criterion is not satisfied, providing the complete combinatorial solution as a best-known solution to the first computational problem.

7. The system of claim 3, wherein the operations comprise:
in response to determining that the at least one diving criterion is not satisfied:
determining whether at least one branching criterion is satisfied; and
in response determining that at least one branching criterion is satisfied, performing another iteration of the branch-and-bound algorithm to identify another single node of the branch-and-bound search tree for further evaluation for the complete combinatorial solution for the first computational problem.

8. The system of claim 1, wherein the quantum computer-based solver is implemented using a quantum annealer.

9. The system of claim 1, wherein the determining of the optimized solution for the second computational problem by using the quantum computer-based solver comprises;
converting the second computational problem to a third computational problem that comprises a quadratic unconstrained binary optimization (QUBO) problem; and
submitting the third computational problem to the quantum computer-based solver to generate the optimized solution.

10. The system of claim 1, wherein the quantum computer-based solver is implemented using a quantum annealer.

11. The system of claim 1, wherein the quantum computer-based solver is implemented using a universal gate quantum computer.

12. The system of claim 1, wherein the first trained machine learning model comprises a trained neural network.

13. The system of claim 12, wherein the trained neural network is trained by performing another branch-and-bound algorithm that uses full strong branching.

14. The system of claim 1, wherein the second trained machine learning model comprises a trained neural network.

15. The system of claim 1, wherein the second trained machine learning model comprises a generative model.

16. The system of claim 1, wherein the second trained machine learning model is trained using training data that comprises a plurality of feasible solutions for combinatorial optimization problems considered during training.

17. The system of claim 1, wherein the second trained machine learning model is trained using training data that comprises a plurality of feasible solutions for combinatorial optimization problems considered during training.

18. A non-transitory computer-readable medium comprising instructions that, when executed by one or more digital hardware processors of a computing device, cause the computing device to perform operations comprising:
accessing a first computational problem comprising a combinatorial optimization problem;
performing a branch-and-bound algorithm to generate a branch-and-bound search tree of the first computational problem and to identify a single node of the branch-and-bound search tree for further evaluation for determining a complete combinatorial solution for the first computational problem, the performing of the branch-and-bound algorithm comprising using a first trained machine learning model as a branching policy for the branching algorithm; and
determining the complete combinatorial solution for the first computational problem based on the branch-and-bound search tree, the determining of the complete combinatorial solution comprising performing an iteration that comprises:
performing a diving algorithm on the branch-and-bound search tree starting from the identified single node, the diving algorithm being configured to determine a partial combinatorial solution for the first computational problem based on the identified single node, the performing of the diving algorithm comprising using a second trained machine learning model as a diving policy for the diving algorithm;
determining, based on the partial combinatorial solution, a second computational problem that comprises a unconstrained binary optimization problem (UBO);
determining an optimized solution for the second computational problem by using a quantum computer-based solver; and
determining the complete combinatorial solution based on the optimized solution and the partial combinatorial solution.

19. The non-transitory computer-readable medium of claim 18, wherein the determining of the optimized solution for the second computational problem by using the quantum computer-based solver comprises:
converting the second computational problem to a third computational problem that comprises a quadratic unconstrained binary optimization (QUBO) problem; and
submitting the third computational problem to the quantum computer-based solver to generate the optimized solution.

20. A method comprising:
accessing, by one or more digital hardware processors, a first computational problem comprising a combinatorial optimization problem;
performing, by the one or more digital hardware processors, a branch-and-bound algorithm to generate a branch-and-bound search tree of the first computational problem and to identify a single node of the branch-and-bound search tree for further evaluation for determining a complete combinatorial solution for the first computational problem, the performing of the branch-and-bound algorithm comprising using a first trained machine learning model as a branching policy for the branching algorithm; and
determining, by the one or more digital hardware processors, the complete combinatorial solution for the first computational problem based on the branch-and-bound search tree, the determining of the complete combinatorial solution comprising performing an iteration that comprises:
performing a diving algorithm on the branch-and-bound search tree starting from the identified single node, the diving algorithm being configured to determine a partial combinatorial solution for the first computational problem based on the identified single node, the performing of the diving algorithm comprising using a second trained machine learning model as a diving policy for the diving algorithm;
determining, based on the partial combinatorial solution, a second computational problem that comprises a unconstrained binary optimization problem (UBO);
determining an optimized solution for the second computational problem by using a quantum computer-based solver; and
determining the complete combinatorial solution based on the optimized solution and the partial combinatorial solution.
